(19) United States
(12) Patent Application Publication
(10) Pub. No.: US 2022/0229295 A1
(43) Pub. Date: Jul. 21, 2022

(54) INFORMATION PROVIDING DEVICE, INFORMATION PROVIDING METHOD, AND STORAGE MEDIUM

(71) Applicant: NEC Corporation, Tokyo (JP)

(72) Inventors: Yuji TAKAGI, Tokyo (JP); Eiji TAKADA, Tokyo (JP); Hironori NAKATA, Tokyo (JP); Hiroki NAOSHIMA, Tokyo (JP); Yuri MASHIMO, Tokyo (JP)

(73) Assignee: NEC Corporation, Tokyo (JP)

(21) Appl. No.: 17/570,598

(22) Filed: Jan. 7, 2022

(30) Foreign Application Priority Data
Jan. 18, 2021 (JP) 2021-005487

(51) Int. Cl. G02B 27/01; H04W 4/029; G02B 27/00; G06T 7/70

(52) U.S. Cl. CPC G02B 27/017; H04W 4/029; G02B 27/0093; G02B 2027/014; G06T 7/70; G02B 2027/0178; G02B 2027/0138; G02B 27/0179

(57) ABSTRACT

An information providing device according to an aspect of the present disclosure includes: at least one memory; and at least one processor configured to execute instructions to: generate, based on measurement data, three-dimensional information of a space in which a wearable terminal is present, the measurement data being measured by a sensor of the wearable terminal; and transmit provision information based on the three-dimensional information to the wearable terminal.

This application is based upon and claims the benefit of priority from Japanese Patent Application No. 2021-005487, filed on Jan. 18, 2021, the disclosure of which is incorporated herein in its entirety by reference.

### TECHNICAL FIELD

The present disclosure relates to a technology for providing information.

### BACKGROUND ART

If a worker at a work site can use a wearable terminal device, for example, smart glasses or the like for collecting information and receiving instructions and information from a command center, both hands can be used for work, and thus work efficiency increases.

JP 2020-160696 A discloses smart glasses that inhibit a process of transmitting image information to an external device from when an imaging range of a camera deviates from a maintenance target area to when the imaging range is included in the maintenance target area.

JP 2020-020987 A discloses an in-company system that displays useful information suitable for a specific occupant, generated on the basis of physical information of the occupant, in a state where the useful information is superimposed on a scene inside and outside a vehicle on smart glasses of the occupant.

JP 2020-030704 A discloses a smart device that displays, on a display, information for guiding an object to an appropriate position on the basis of accompanying information regarding alignment with respect to the object and a measurement result of the object by a sensor, the information being at least partially superimposed on a video of the object.

### SUMMARY

One example of an object of the present disclosure is to provide an information providing device or the like capable of improving safety of a worker.

An information providing device according to one aspect of the present disclosure includes a generation unit that generates three-dimensional information of a space in which a wearable terminal is present on the basis of measurement data measured by a sensor of the wearable terminal, and a transmission unit that transmits provision information based on the three-dimensional information to the wearable terminal.

An information providing method according to one aspect of the present disclosure includes generating three-dimensional information of a space in which a wearable terminal is present on the basis of measurement data measured by a sensor of the wearable terminal, and transmitting provision information based on the three-dimensional information to the wearable terminal.

A storage medium according to one aspect of the present disclosure stores a program for causing a computer to execute a generation process of generating three-dimensional information of a space in which a wearable terminal is present on the basis of measurement data measured by a sensor of the wearable terminal, and a transmission process of transmitting provision information based on the three-dimensional information to the wearable terminal.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of an information providing device according to a first example embodiment of the present disclosure;

FIG. 2 is a flowchart illustrating an example of an operation of the information providing device according to the first example embodiment of the present disclosure;

FIG. 3 is a block diagram illustrating an example of a configuration of an information providing system according to a second example embodiment of the present disclosure;

FIG. 4 is a block diagram illustrating an example of a configuration of a wearable terminal according to the second example embodiment of the present disclosure;

FIG. 5 is a block diagram illustrating an example of a configuration of an information providing device according to the second example embodiment of the present disclosure;

FIG. 6 is a flowchart illustrating an example of a first operation of the wearable terminal according to the second example embodiment of the present disclosure;

FIG. 7 is a flowchart illustrating an example of an operation of the information providing device according to the second example embodiment of the present disclosure;

FIG. 8 is a flowchart illustrating an example of a second operation of the wearable terminal according to the second example embodiment of the present disclosure; and

FIG. 9 is a diagram illustrating an example of a hardware configuration of a computer that can implement the information providing devices and the wearable terminal according to the example embodiments of the present disclosure.

### EXAMPLE EMBODIMENT

Hereinafter, example embodiments of the present disclosure will be described in detail using the drawings.

### First Example Embodiment

First, a first example embodiment of the present disclosure will be described.

<Overview>

An information providing device according to the first example embodiment of the present disclosure is communicably connected to a wearable terminal. The wearable terminal is worn by, for example, a worker who works in a place where visibility by a naked eye is poor. Such a worker is, for example, a firefighter or the like who performs rescue activities, fire extinguishing activities, and the like inside a building in which a fire has occurred. The information providing device receives measurement data measured by a sensor of the wearable terminal, and generates three-dimensional information of a space in which the wearable terminal is present on the basis of the measurement data. The space where the wearable terminal is present is, for example, the inside of a building where a firefighter or the like is working. The information providing device provides the wearable terminal with provision information based on the generated three-dimensional information.

<Configuration>

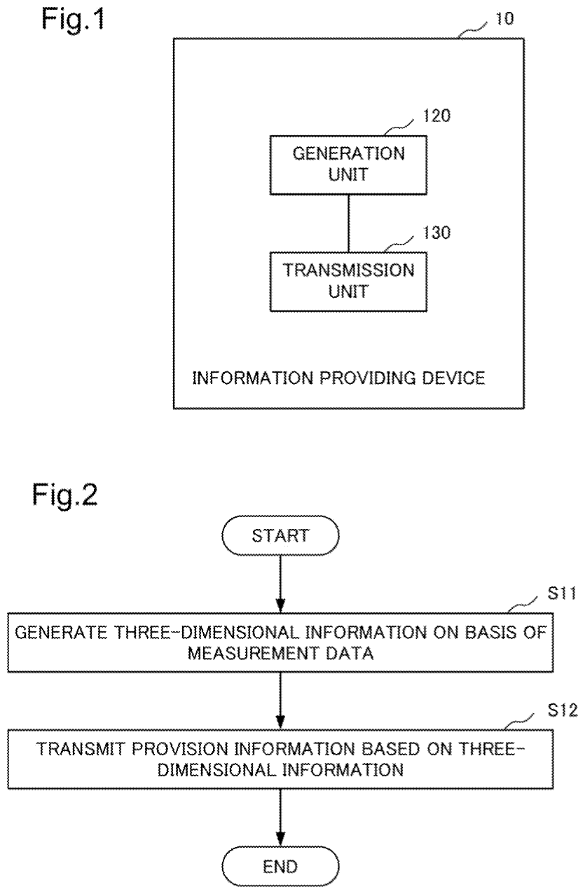

FIG. 1 is a block diagram illustrating an example of a configuration of an information providing device 10 according to a first example embodiment of the present disclosure. In the example illustrated in FIG. 1, the information providing device 10 includes a generation unit 120 and a transmission unit 130. The information providing device 10 is communicably connected to, for example, a wearable terminal such as smart glasses via, for example, a wireless communication network.

The wearable terminal includes a sensor, a device (for example, at least one of a display device or a sound reproducing device, and the like) that transmits information to a user of the wearable terminal, and a communication function that communicates with the information providing device 10. The sensor is, for example, a camera. The sensor may be a plurality of cameras. The sensor may be, for example, a Light Detection And Ranging/Laser Imaging, Detection And Ranging (LIDAR) type distance measuring device that measures a distance to an object. The sensor may include a distance sensor, such as an ultrasonic sensor or a laser range finder, that measures a distance to a surrounding object. The sensor may include, for example, a plurality of distance sensors mounted to measure different directions. The sensor may be a combination of a plurality of sensors of multiple types. In the present example embodiment, the sensor is one camera. An example in which the sensor includes a sensor other than one camera will be described as a modification example of the second example embodiment described later.

The wearable terminal transmits measurement data, which is data obtained by measurement by the sensor, to the information providing device 10 by the communication function. The wearable terminal receives information from the information providing device 10 by the communication function. The wearable terminal notifies the user of the wearable terminal of the received information by a device that notifies the user of information. The wearable terminal is, for example, a wearable terminal 200 to be described later.

<Generation Unit 120>

The generation unit 120 generates three-dimensional information of the space in which the wearable terminal is present on the basis of the measurement data measured by the sensor of the wearable terminal. The three-dimensional information of the space is, for example, information of a three-dimensional structure of a surface such as an object or a structure, which can be measured by a sensor. In a case where the sensor is a camera, a video, that is, a plurality of images from a plurality of different viewpoints captured by the moving camera is obtained by capturing by the camera of the wearable terminal worn by the moving user. From such an image, the generation unit 120 generates three-dimensional information of the space in which the wearable terminal is present by a method, for example, structure from motion (SfM) or the like.

<Transmission Unit 130>

The transmission unit 130 transmits information (hereinafter, also referred to as provision information) based on the generated three-dimensional information to the wearable terminal. The information based on the three-dimensional information is, for example, information contributing to safety of the worker wearing the wearable terminal, such as information of a path, information of a range that is passable, and information of an obstacle. The information based on the three-dimensional information is not limited to these examples. The information based on the three-dimensional information will be described in detail later.

<Operation>

FIG. 2 is a flowchart illustrating an example of an operation of the information providing device 10 according to the first example embodiment of the present disclosure. In the example illustrated in FIG. 2, first, the generation unit 120 generates the three-dimensional information on the basis of the measurement data (step S11). Then, the transmission unit 130 transmits the provision information based on the three-dimensional information (step S12).

<Effects>

The present example embodiment has an effect that the safety of the worker can be improved. This is because the generation unit 120 generates the three-dimensional information on the basis of the measurement data, and the transmission unit 130 transmits the provision information based on the generated three-dimensional information.

### Second Example Embodiment

Hereinafter, a second example embodiment of the present disclosure will be described in detail using drawings.

<Information Providing System 1>

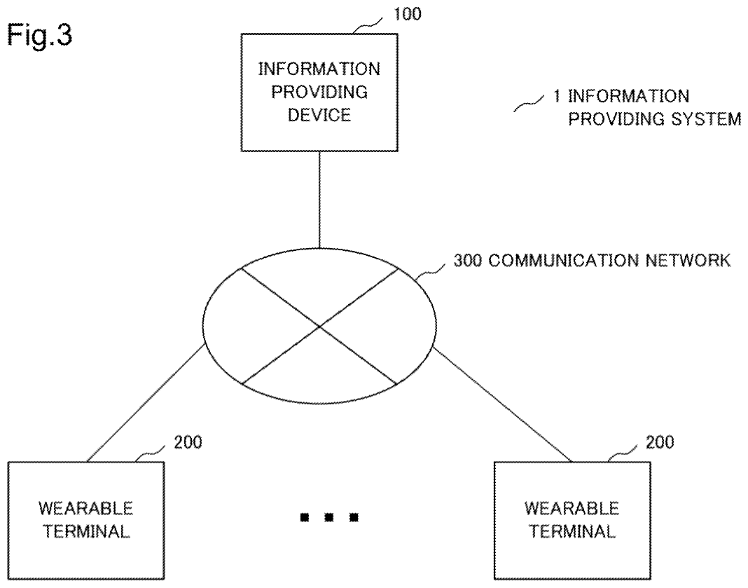

FIG. 3 is a block diagram illustrating an example of a configuration of an information providing system 1 according to the second example embodiment of the present disclosure. In the example illustrated in FIG. 3, the information providing system 1 includes an information providing device 100 and a plurality of wearable terminals 200. The information providing device 100 is communicably connected to each of the plurality of wearable terminals 200 via a communication network 300. In the example illustrated in FIG. 3, the information providing system 1 includes a plurality of wearable terminals, but the information providing system 1 may include one wearable terminal. As described above, the user of the wearable terminal is a worker such as a firefighter. The wearable terminal is worn by a user, that is, for example, a firefighter or the like. The information providing system 1 is installed, for example, in a command center or the like.

<Communication Network 300>

The communication network 300 is a communication network that mediates communication between the information providing device 100 and the wearable terminals 200. The wearable terminals 200 are connected to the communication network 300 by wireless communication.

<Wearable Terminal 200>

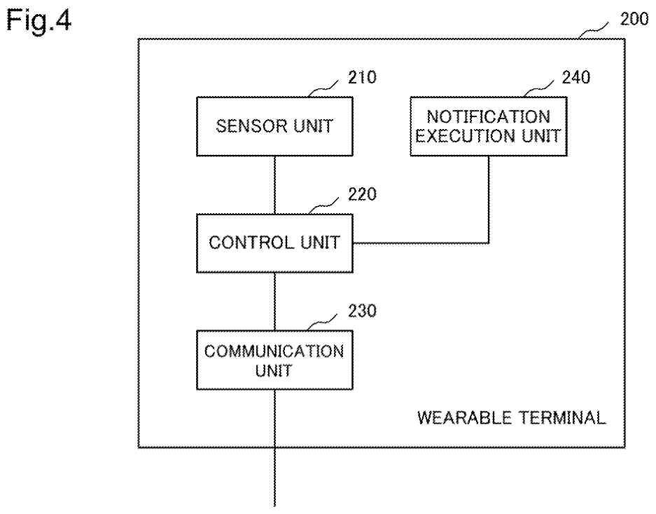

FIG. 4 is a block diagram illustrating an example of a configuration of the wearable terminal 200 according to the second example embodiment of the present disclosure. In the example illustrated in FIG. 4, the wearable terminal 200 includes a sensor unit 210, a control unit 220, a communication unit 230, and a notification execution unit 240. The wearable terminal 200 is implemented as, for example, smart glasses. The implementation of the wearable terminal 200 is not limited to the smart glasses.

<Sensor Unit 210>

In the present example embodiment, the sensor unit 210 is, for example, a camera that captures a front video of the user wearing the wearable terminal. In the present example embodiment, measurement data obtained by measurement by the sensor unit 210 (in other words, by the sensor unit 210) is a plurality of images. The plurality of images may be a moving image (hereinafter, also referred to as video). The sensor unit 210 may include other types of sensors. An example in which the sensor unit 210 includes another type of sensor will be described later.

<Control Unit 220>

The control unit 220 transmits the measurement data obtained by the sensor unit 210 to the information providing device 100 via the communication unit 230. The control unit 220 receives the provision information from the information providing device 100 via the communication unit 230. The control unit 220 notifies the user of the wearable terminal of the provision information by the notification execution unit 240.

<Communication Unit 230>

The communication unit 230 is a communication interface that mediates communication between the control unit 220 and the information providing device 100 via the communication network 300. The communication unit 230 is connected to the communication network 300 by wireless communication. Communication between the communication unit 230 and the information providing device 100 is not limited to wireless communication.

<Notification Execution Unit 240>

The notification execution unit 240 notifies the user of the wearable terminal of the provision information. The notification execution unit 240 may be implemented as a display device such as a display of smart glasses. The notification execution unit 240 may be implemented as an audio reproduction device such as a speaker, a headphone, or an earphone. The provision information and the method of notifying the provision information will be described in detail later.

<Information Providing Device 100>

Next, an information providing device 100 according to the second example embodiment of the present disclosure will be described in detail with reference to the drawings.

<Configuration>

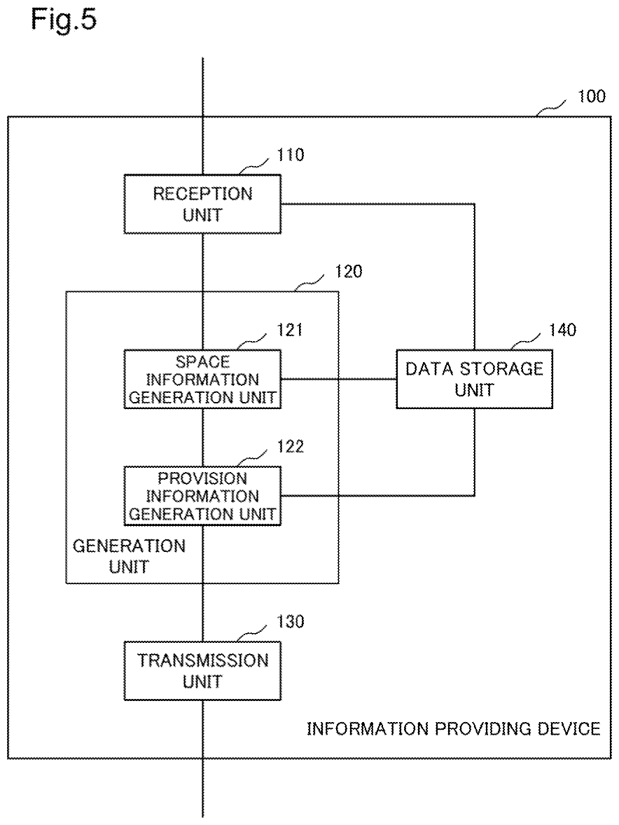

FIG. 5 is a block diagram illustrating an example of a configuration of the information providing device 100 according to the second example embodiment of the present disclosure. In the example illustrated in FIG. 5, the information providing device 100 of the present example embodiment includes a reception unit 110, a generation unit 120, a transmission unit 130, and a data storage unit 140. The generation unit 120 includes a space information generation unit 121 and a provision information generation unit 122.

<Reception Unit 110>

The reception unit 110 receives the measurement data obtained by measurement by the sensor unit 210 of the wearable terminal from the wearable terminal 200. In the description of the present example embodiment, the measurement data is a plurality of images (for example, a video). The reception unit 110 stores the acquired measurement data in the data storage unit 140. The reception unit 110 sends the acquired measurement data to the space information generation unit 121 of the generation unit 120.

<Generation Unit 120>

As described above, the generation unit 120 includes the space information generation unit 121 and the provision information generation unit 122. The functions and operations of the space information generation unit 121 and the provision information generation unit 122 can be said to be the functions and operations of the generation unit 120.

<Space Information Generation Unit 121>

The space information generation unit 121 receives the measurement data from the reception unit 110. The space information generation unit 121 generates three-dimensional information of the space in which the wearable terminal is present on the basis of the received measurement data. In the present example embodiment, the measurement data is, for example, a plurality of images obtained as a video. The space information generation unit 121 generates three-dimensional information of the space in which the wearable terminal is present from the plurality of images by a method such as SfM. The generated three-dimensional information is referred to as new three-dimensional information.

In a case where the three-dimensional information of the space in which the wearable terminal is present is stored in the data storage unit 140, the space information generation unit 121 reads the three-dimensional information stored in the data storage unit 140. The three-dimensional information stored in the data storage unit 140 is referred to as stored three-dimensional information. The space information generation unit 121 generates combined three-dimensional information by combining the new three-dimensional information and the stored three-dimensional information. A method by which the space information generation unit 121 combines the new three-dimensional information and the stored three-dimensional information may be any of various existing methods. In a case where the stored three-dimensional information does not exist, the space information generation unit 121 assumes the new three-dimensional information as the combined three-dimensional information.

The three-dimensional information is represented by, for example, coordinates of a plurality of points in an appropriately set coordinate system. The space information generation unit 121 may estimate horizontal planes such as the floor and the ceiling in the image captured by the camera of the wearable terminal on the assumption that time during which the user's head is not tilted is long. The space information generation unit 121 may set the coordinate axis in a vertical direction in a coordinate system of the three-dimensional information to a direction perpendicular to a horizontal plane estimated from the image in the three-dimensional space. The space information generation unit 121 may appropriately determine the other two coordinate axes included in the horizontal plane to be, for example, a direction perpendicular to a plane such as a wall orthogonal to the horizontal plane or a direction orthogonal to such a plane. Each of the plurality of points is, for example, a point in a three-dimensional space where a figure is obtained as points on an image whose association among the plurality of images is specified. For example, the space information generation unit 121 performs coordinate transformation on the new three-dimensional information such that a size of a common part (hereinafter, also referred to as an overlap) between the new three-dimensional information and the stored three-dimensional information becomes the largest. The space information generation unit 121 adds the new three-dimensional information subjected to such coordinate transformation to the stored three-dimensional information, and assumes the stored three-dimensional information to which the new three-dimensional information subjected to the coordinate transformation is added as the combined three-dimensional information.

At that time, for example, in a case where the coordinate transformation by rotation and parallel movement is performed on the coordinates of the plurality of points included in the new three-dimensional information, the space information generation unit 121 calculates the coordinate transformation that maximizes the overlap with the stored three-dimensional information. For example, the space information generation unit 121 may determine, as the size of the overlap, the number of combinations in which a distance between two points is equal to or less than a predetermined distance among combinations of a point included in the new three-dimensional information subjected to the coordinate transformation and a point included in the stored three-dimensional space information closest to the point. A building has many flat surfaces such as a wall, a floor, and a ceiling. Therefore, the space information generation unit 121 may derive one or more planes (for example, a plane in which the number of points whose distance from the plane is less than a predetermined distance is equal to or greater than a predetermined number) that can be regarded as each including any plurality of points from the coordinates of the plurality of points of the stored three-dimensional space information. Hereinafter, these planes are also referred to as an approximate plane. The space information generation unit 121 may determine the number of points whose distance to the derived plane (that is, the approximate plane) is less than a predetermined distance among the plurality of points included in the new three-dimensional information subjected to the coordinate transformation as the size of the overlap.

The space information generation unit 121 may perform noise removal on the combined three-dimensional information. The noise removal may be, for example, removing, as noise, a point at which the distance to the closest plane among the derived planes described above exceeds a predetermined distance. The noise removal may be, for example, associating information indicating noise with a point at which the distance to the closest plane among the derived planes described above exceeds a predetermined distance.

The space information generation unit 121 stores the combined three-dimensional information in the data storage unit 140.

The space information generation unit 121 estimates a position and a direction of the user wearing the wearable terminal 200 in the space represented by the combined three-dimensional information on the basis of a distribution range of the new three-dimensional information in the combined three-dimensional information, for example. The relationship between the direction of the camera of the wearable terminal 200 and the direction (for example, the direction in which the user's face is facing) of the user wearing the wearable terminal 200 and camera parameters of the camera are given in advance to the space information generation unit 121. For example, in a case where the wearable terminal 200 is a device such as smart glasses worn on the head of the user and the camera is mounted so as to capture of the front of the user wearing the wearable terminal 200, the direction of the user can be regarded as the same as the direction of the camera. The space information generation unit 121 estimates the direction of the camera on the basis of the range of the distribution (that is, the distribution of the coordinates of points included in the new three-dimensional information after the coordinate transformation) of the new three-dimensional information related to the capturing range of the camera. The space information generation unit 121 calculates coordinates of the position of the camera in the coordinate system based on the combined three-dimensional information on the basis of camera parameters such as an angle of view and a focal length, and the distribution range of the new three-dimensional information. The space information generation unit 121 assumes the position of the camera represented by the calculated coordinates as the position of the user. The space information generation unit 121 stores information indicating the position and direction of the user (hereinafter also referred to as position information) in the data storage unit 140.

The space information generation unit 121 sends the combined three-dimensional information and information indicating the position and direction of the user (that is, the position information of the user) to the provision information generation unit 122.

<Provision Information Generation Unit 122>

The provision information generation unit 122 receives the combined three-dimensional information and the position information of the user from the space information generation unit 121. The provision information generation unit 122 generates provision information that is information to be provided to the wearable terminal 200 on the basis of the combined three-dimensional information and the information indicating the position of the user. In the present example embodiment, the provision information is information based on the combined three-dimensional information. Specifically, the provision information is information of a structure existing in front when facing the direction indicated by the position information at the position indicated by the position information in the structure indicated by the combined three-dimensional information. For example, the information of the structure may be represented by an intersection line that is not hidden by any of the approximate planes at a viewpoint facing a direction represented by the position information at a position represented by the position information among intersection lines of the approximate planes of the combined three-dimensional information. The information of the structure existing in front may be, for example, information of intersection lines captured in a case where capturing is performed by a camera having a predetermined angle of view at the above-described viewpoint. The provision information is not limited to these examples. Another example of the provision information will be described in detail later.

The provision information generation unit 122 transmits the provision information to the wearable terminal 200 via the transmission unit 130. Specifically, the provision information generation unit 122 transmits the provision information to the transmission unit 130.

<Transmission Unit 130>

The transmission unit 130 receives the provision information from the provision information generation unit 122. The transmission unit 130 transmits the received provision information to the wearable terminal 200.

In the example of the present example embodiment, the provision information is information of a structure existing in front. The control unit 220 of the wearable terminal 200 receives the provision information via the communication unit 230. The control unit 220 generates an image representing a structure existing in front from the received provision information (that is, information indicating a structure existing in front), and displays the generated image on the notification execution unit 240 that is a display device.

<Operation>

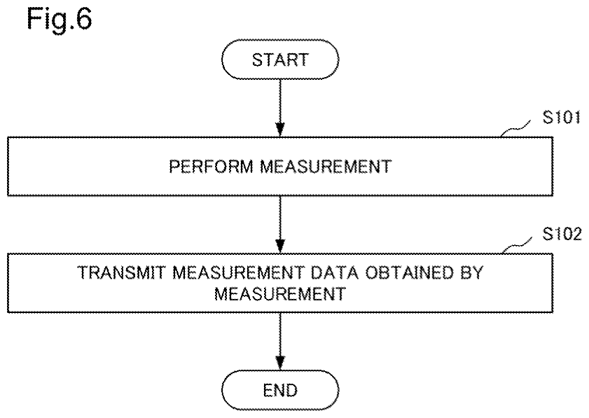

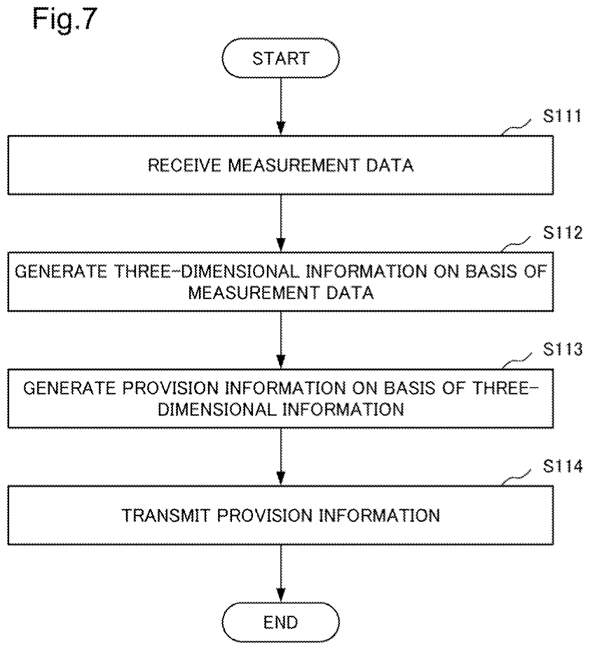

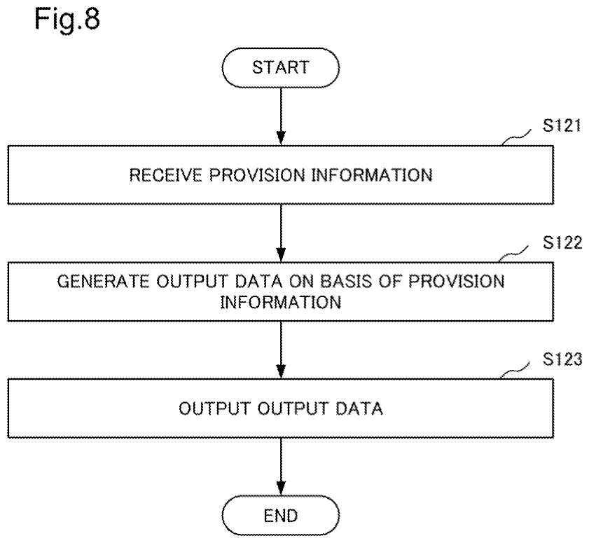

Next, an operation of the information providing system 1 according to the second example embodiment of the present disclosure will be described in detail with reference to the drawings. In the operation of the information providing system 1 of the present example embodiment, the measurement data obtained by the operation of the wearable terminal 200 illustrated in FIG. 6 is used in an operation of the information providing device 100 illustrated in FIG. 7. Then, the provision information generated by the operation of the information providing device 100 illustrated in FIG. 7 is used in operation of the wearable terminal 200 illustrated in FIG. 8. However, the operation illustrated in FIG. 6, the operation illustrated in FIG. 7, and the operation illustrated in FIG. 8 may be performed in parallel.

FIG. 6 is a flowchart illustrating an example of a first operation of the wearable terminal 200 according to the second example embodiment of the present disclosure. In the example illustrated in FIG. 6, first, the control unit 220 performs measurement by the sensor unit 210 (step S101). The control unit 220 transmits the measurement data obtained by the measurement to the information providing device 100 via the communication unit 230 (step S102).

FIG. 7 is a flowchart illustrating an example of the operation of the information providing device 100 according to the second example embodiment of the present disclosure. In the example illustrated in FIG. 7, the reception unit 110 receives the measurement data from the wearable terminal 200 (step S111). The space information generation unit 121 generates three-dimensional information on the basis of the measurement data (step S112). Specifically, the space information generation unit 121 generates the above-described new three-dimensional information, and generates combined three-dimensional information and position information from the generated new three-dimensional information and the above-described stored three-dimensional information. Next, the provision information generation unit 122 generates the provision information on the basis of the three-dimensional information (step S113). Specifically, the provision information generation unit 122 generates the provision information described above, for example, on the basis of the combined three-dimensional information and the position information. Then, the transmission unit 130 transmits the provision information to the wearable terminal 200 (step S114).

FIG. 8 is a flowchart illustrating an example of a second operation of the wearable terminal 200 according to the second example embodiment of the present disclosure. In the example illustrated in FIG. 8, the control unit 220 receives the provision information from the information providing device 100 via the communication unit 230 (step S121). The control unit 220 generates output data on the basis of the provision information (step S122). The output data is, for example, an image representing the above-described structure existing in front. The control unit 220 outputs the output data by the notification execution unit 240 that is, for example, a display device (step S123). Specifically, for example, the control unit 220 displays the image representing the structure existing in front on the notification execution unit 240 that is a display.

<Effects>

The present example embodiment has the same effect as that of the first example embodiment. That is, the present example embodiment has an effect that the safety of the worker can be improved. This is because the generation unit 120 generates the three-dimensional information on the basis of the measurement data, and the transmission unit 130 transmits the provision information based on the generated three-dimensional information.

The effect of the present example embodiment will be further described. For example, in a fire site or the like where a user who is a firefighter wears the wearable terminal 200 to engage in activities, a range in which the field of view is shielded may be widened due to an increase in smoke during the activity.

However, if there is an image captured before the smoke spreads, information indicating the structure of the space in the area where the view is shielded by the spread of the smoke is also generated on the basis of the image. In that case, the user can also know the structure of the space in the area where the view is shielded by the smoke by the image representing the structure existing in front, which is the provision information generated on the basis of the images captured in the present and past. This enhances the safety of the activity of the user.

### Modification Example of Second Example Embodiment

### First Modification Example

The wearable terminal 200 may include a stereo camera as the sensor unit 210. In this case, the control unit 220 of the wearable terminal 200 sends a plurality of combinations of two images captured in synchronization by two cameras included in the stereo camera to the information providing device 100 as the measurement data.

The space information generation unit 121 of the information providing device 100 generates the new three-dimensional information on the basis of the two images captured in synchronization. The space information generation unit 121 can generate the new three-dimensional information using any of various existing methods for reconstructing three-dimensional data from two images obtained by the stereo camera.

### Second Modification Example

The wearable terminal 200 may include a distance measuring device of a LIDAR system as the sensor unit 210. In this case, the space information generation unit 121 generates the three-dimensional information of the space in which the wearable terminal is present from a distribution of points whose distance is measured by the LIDAR. A method by which the space information generation unit 121 generates the three-dimensional information of the space in which the wearable terminal is present from the distribution of the points whose distance is measured by the LIDAR may be any of various existing methods.

### Third Modification Example

The reception unit 110 may receive the measurement data from a plurality of wearable terminals 200 existing in the same space (for example, the interior of the same building). The space information generation unit 121 may combine new three-dimensional data generated from the measurement data received from each of the plurality of wearable terminals 200 with same stored three-dimensional data. The provision information generation unit 122 generates the provision information from the stored three-dimensional data based on the measurement data obtained by measurement by the plurality of wearable terminals 200. In other words, it can be said that the provision information generation unit 122 generates the provision information also on the basis of the measurement data obtained by measurement by another wearable terminal 200. The another wearable terminal 200 refers to a wearable terminal other than the wearable terminal 200 to which the generated provision information is transmitted. The provision information in this case may be the same as the provision information in the description of the second example embodiment.

### Fourth Modification Example

In the data storage unit 140, data indicating a three-dimensional structure inside the building where the wearable terminal 200 is present may be stored in advance as the stored three-dimensional information. In this case, the space information generation unit 121 also handles the stored three-dimensional information as the combined three-dimensional information. The space information generation unit 121 does not combine the new three-dimensional information and the stored three-dimensional information.

### Fifth Modification Example

The sensor unit 210 of the wearable terminal 200 may include one or more distance measurement sensors using an ultrasonic wave, a laser, or the like. The distance measurement sensor in this case is not required to be the LIDAR. The control unit 220 transmits the measurement data further including distance data obtained by the distance measurement sensor to the information providing device 100.

The space information generation unit 121 holds in advance information indicating a relative position of the distance measurement sensor attached to the wearable terminal 200 with respect to the camera and information indicating a direction of the distance measurement sensor with respect to the direction of the camera. Hereinafter, the information indicating the relative position of the distance measurement sensor attached to the wearable terminal 200 with respect to the camera and the information indicating the direction of the distance measurement sensor with respect to the direction of the camera are referred to as positional relationship information. Such positional relationship information may be given to the space information generation unit 121 by, for example, an administrator of the information providing system 1.

The space information generation unit 121 may correct the position and direction of the camera calculated using the image obtained by capturing by the camera as follows, for example, using the positional relationship information between the camera and the distance measurement sensor and the data of the distance measured by the distance measurement sensor. The position and direction of the distance measurement sensor can be specified by the calculated position and direction of the camera and the positional relationship information between the camera and the distance measurement sensor. The space information generation unit 121 may correct the position and direction of the camera so that the distance to the approximate plane of the combined three-dimensional information measured by the distance measurement sensor in the position and direction specified in such a manner becomes closer to the distance indicated by the measurement data included in the received measurement data.

### Sixth Modification Example

The sensor unit 210 of the wearable terminal 200 may include at least one of an acceleration sensor that measures acceleration data for estimating an elevation angle of the wearable terminal or an orientation sensor that measures a direction. The control unit 220 transmits the measurement data including acceleration data obtained by measurement by the acceleration sensor and orientation data obtained by measurement by the orientation sensor to the information providing device 100.

The space information generation unit 121 holds in advance the relationship between the direction of the camera and the coordinate system based on the direction of the acceleration (in other words, an acceleration vector) measured by the acceleration sensor provided by the administrator of the information providing system 1, for example. The space information generation unit 121 holds in advance the relationship between the direction of the camera and the direction measured by the orientation sensor provided by, for example, the administrator of the information providing system 1. The space information generation unit 121 calculates a camera elevation angle on the basis of the relationship between the direction of the camera and the coordinate system based on the acceleration vector, and the acceleration data included in the measurement data. The space information generation unit 121 calculates an orientation of the direction of the camera (that is, a direction in which the direction of the camera is projected on the horizontal plane) from the relationship between the direction of the camera and the direction measured by the orientation sensor and the orientation data included in the measurement data.

The space information generation unit 121 estimates the direction of gravity on the basis of the acceleration data. The space information generation unit 121 may estimate an elevation angle (that is, an angle formed by the optical axis of the camera and the horizontal plane) of the camera on the basis of the estimated direction of gravity. The space information generation unit 121 may estimate the horizontal plane in the new three-dimensional information on the basis of the direction of gravity or the elevation angle of the camera. The space information generation unit 121 may determine coordinate transformation (or the initial value of a parameter in a search for parameters of the coordinate transformation) to be performed on the new three-dimensional information when extracting a common part between the new three-dimensional information and the stored three-dimensional information on the basis of the direction of gravity or the elevation angle of the camera and the orientation of the camera.

### Seventh Modification Example

The space information generation unit 121 stores a transition of the position of the wearable terminal 200 in the stored three-dimensional information in the data storage unit 140. The transition of the position of the wearable terminal 200 is, for example, time-series data of coordinates indicating the position of the wearable terminal 200.

On the basis of the time series of coordinates indicating the position of the wearable terminal 200 and the combined three-dimensional information, the space information generation unit 121 may derive a path toward the position (hereinafter, referred to as an initial position) indicated by a first coordinate of the time-series data in the combined three-dimensional information. The space information generation unit 121 may use a path that follows the time series of coordinates indicating the position of the wearable terminal 200 in reverse as a path toward the initial position. The space information generation unit 121 may detect a range in which a round trip is made on the same path from a path that follows the time series of coordinates indicating the position of the wearable terminal 200 in reverse. The space information generation unit 121 may set a path obtained by excluding the detected range from a path that follows the time series of coordinates indicating the position of the wearable terminal 200 in reverse as a path toward the initial position. The space information generation unit 121 may detect a loop range that returns to the same point through any path from a path that follows the time series of coordinates indicating the position of the wearable terminal 200 in reverse. The space information generation unit 121 may set a path obtained by excluding a detected loop range from a path that follows the time series of coordinates indicating the position of the wearable terminal 200 in reverse as a path toward the initial position. For example, the space information generation unit 121 may set, as the same point, two positions between which the above-described approximate plane does not exist and in which the distance between the two positions is equal to or less than a predetermined distance.

The provision information generation unit 122 may generate a display representing a path (hereinafter, referred to as a return path) from the position (hereinafter, referred to as a current position) of the wearable terminal 200 toward the initial position as the provision information. Information indicating the return path may be, for example, data indicating a figure of a line of an image obtained when a line obtained by connecting positions included in the return path in a time-series order (or a reverse order of a time-series order) is captured by a camera existing at the current position and facing the estimated direction. The information indicating the return path may be, for example, data indicating a figure of a line of an image obtained when an arrow in a direction toward a position closest to the current position among positions included in a path from the position (hereinafter, referred to as a current position) of the wearable terminal 200 toward the initial position is captured by a camera existing at the current position and facing the estimated direction. The information indicating the return path may be other information. The provision information generation unit 122 transmits the information indicating the return path to the wearable terminal 200 as the provision information.

The control unit 220 of the wearable terminal 200 receives the information indicating the return path from the information providing device 100 via the communication unit 230 as the provision information. The control unit 220 may display the information indicating the return path on the notification execution unit 240 that is a display. The control unit 220 may superimpose the information indicating the return path on the video in front of the wearable terminal captured by the camera. The control unit 220 may display the video in front of the wearable terminal on which the information indicating the return path is superimposed on the notification execution unit 240 that is a display.

### Eighth Modification Example

In the seventh modification example, the space information generation unit 121 uses a time series of coordinates indicating the position of one wearable terminal 200. On the other hand, the space information generation unit 121 of the eighth modification example uses a time series of coordinates indicating positions of a plurality of wearable terminals including other wearable terminals 200. The space information generation unit 121 generates a plurality of polygonal lines by connecting adjacent positions in a time series by line segments from each of a plurality of time series. The space information generation unit 121 integrates the generated plurality of polygonal lines. The integration method may be any of various existing methods. The space information generation unit 121 may integrate the generated plurality of polygonal lines, for example, as follows. For example, the space information generation unit 121 may appropriately select one position from two positions in which a distance between the two positions is equal to or less than a predetermined distance, and re-connect a line segment connected to a position that has not been selected to the selected position. The space information generation unit 121 detects a combination of a plurality of paths from one point toward another point. In a case where such a combination is detected, the space information generation unit 121 selects a path having the shortest distance from among paths included in the detected combination, and erases unselected paths. The path represented by the integrated polygonal line is referred to as an integrated path.

In the integrated path, the space information generation unit 121 sets a path having the shortest distance from the current position of the wearable terminal 200 toward the initial position as the return path.

When information of the structure of the building into which the user of the wearable terminal 200 has entered has been obtained, the space information generation unit 121 is not required to use the time series of coordinates indicating the positions of the plurality of wearable terminals. In that case, the space information generation unit 121 extracts a path with the shortest distance from the current position of the wearable terminal 200 toward the initial position by using the information of the structure of the building into which the user of the wearable terminal 200 has entered.

The eighth modification example is the same as the seventh modification example except for the difference described above.

### Ninth Modification Example

As described above, the reception unit 110 stores the measurement data in the data storage unit 140. In other words, the reception unit 110 stores a video (that is, a plurality of images) captured by the camera of the wearable terminal 200 and received as at least a part of the measurement data in the data storage unit 140.

The space information generation unit 121 stores the calculated camera position (for example, coordinates indicating a position) and direction (for example, direction vector representing a direction) in the data storage unit 140. The data indicating the position and orientation of the camera may be represented in a coordinate system on which the stored three-dimensional information is based. The space information generation unit 121 associates the video (that is, a plurality of images) stored in the data storage unit 140 with the position and direction of the camera at the time of capturing the video.

The provision information generation unit 122 selects an image that is least shielded by smoke or the like from among images associated with the position and the direction that satisfy criteria relating to the position and the direction of the camera at the current position. The provision information generation unit 122 may detect an area of smoke or the like by any of existing methods for detecting an area of smoke or the like (for example, smoke, or smoke and flame, or the like), for example, and may set a ratio of the detected area of smoke or the like as a size of a shield. The criteria relating to the position and direction of the camera at the current position is, for example, that a difference in position is equal to or less than a predetermined distance, and a difference in accuracy is equal to or less than a predetermined accuracy. The provision information generation unit 122 transmits the selected image to the wearable terminal 200 as the provision information.

The control unit 220 of the wearable terminal 200 receives the selected image as the provision information from the information providing device 100 via the communication unit 230. The control unit 220 displays the received image on the notification execution unit 240 that is a display.

### Tenth Modification Example

A tenth modification example is the same as the ninth modification example except for the following differences.

The provision information generation unit 122 extracts an image (hereinafter, referred to as a partial image) of a portion related to an area (hereinafter, referred to as a shielded area) of smoke or the like detected from the received latest image from a selected image that is least shielded. The provision information generation unit 122 transmits the partial image of the selected image related to a shielded portion to the wearable terminal 200 as the provision information.

The control unit 220 of the wearable terminal 200 receives the partial image of the selected image as the provision information from the information providing device 100 via the communication unit 230. The control unit 220 displays the received partial image on the notification execution unit 240 that is a display.

The provision information generation unit 122 may transmit the partial image of the selected image related to the shielded portion and information indicating a range of the shielded area to the wearable terminal 200.

The control unit 220 of the wearable terminal 200 receives the partial image of the selected image and the information indicating the range of the shielded area as the provision information from the information providing device 100 via the communication unit 230. The control unit 220 may superimpose the received partial image on the range of the shielded area of an image captured by the camera of the wearable terminal 200. The control unit 220 may display, on the notification execution unit 240 that is a display, the image captured by the camera of the wearable terminal 200 on which the received partial image is superimposed on the range of the shielded area.

### Eleventh Modification Example

An eleventh modification example is the same as the ninth modification example except for the following differences.

The provision information generation unit 122 transmits the above-described “information of the structure existing in front” of the selected image that is least shielded and on which, for example, a picture is drawn by a line to the wearable terminal 200 as the provision information.

The control unit 220 of the wearable terminal 200 receives, as the provision information, information of a structure existing in front of the selected image from the information providing device 100 via the communication unit 230. The control unit 220 displays the received information of the structure existing in front on the notification execution unit 240 that is a display. The control unit 220 may superimpose the received information of the structure existing in front on the image captured by the camera of the wearable terminal 200. The control unit 220 may display, on the notification execution unit 240 that is a display, the image captured by the camera of the wearable terminal 200 on which the received information of the structure existing in front is superimposed.

### Twelfth Modification Example

A twelfth modification example is the same as the eleventh modification example except for the following differences.

The provision information generation unit 122 may extract the above-described “information of the structure existing in front” of a portion related to a shielded area detected from the received latest image of a selected image that is least shielded. The provision information generation unit 122 may transmit the extracted information of the structure existing in front of the image that is least shielded and the information indicating the range of the shielded portion to the wearable terminal 200 as the provision information.

The control unit 220 of the wearable terminal 200 receives, from the information providing device 100 via the communication unit 230, the extracted information of the structure existing in front of the image that is least shielded and the information indicating the range of the shielded portion as the provision information. The control unit 220 may display the received information of the structure existing in front on the notification execution unit 240 that is a display. The control unit 220 may superimpose the received information of the structure existing in front on the range of the shielded portion of the image captured by the camera of the wearable terminal 200. The control unit 220 may display, on the notification execution unit 240 that is a display, the image captured by the camera of the wearable terminal 200 on which the received information of the structure existing in front is superimposed on the range of the shielded portion.

### Thirteenth Modification Example

A thirteenth modification example is the same as the twelfth modification example except for differences described below.

The provision information generation unit 122 transmits, as the provision information, the extracted information of the structure existing in front of the image that is least shielded and the information indicating the range of the shielded portion to the wearable terminal 200, as does the provision information generation unit 122 of the twelfth modification example. The provision information generation unit 122 may further transmit information of a structure existing in front of the received latest image to the wearable terminal 200 as the provision information.

The control unit 220 of the wearable terminal 200 receives, as the provision information, the extracted information of the structure existing in front of the image that is least shielded and the information indicating the range of the shielded portion from the information providing device 100 via the communication unit 230, as does the control unit 220 of the twelfth modification example.

The control unit 220 further receives the information of the structure existing in front of the received latest image from the information providing device 100 as the provision information.

The control unit 220 may display the received information of the structure existing in front of the selected image and the received information of the structure existing in front of the latest image on the notification execution unit 240 that is a display.

The control unit 220 may superimpose the information of the structure existing in front of the selected image on the range of the shielded portion of the image captured by the camera of the wearable terminal 200. The control unit 220 may superimpose the information of the structure existing in front of the latest image on the image on which the information of the structure existing in front of the selected image is superimposed. The control unit 220 may display, on the notification execution unit 240 that is a display, the image captured by the camera of the wearable terminal 200 on which the information of the structure existing in front of the selected image and the information of the structure existing in front of the latest image are superimposed.

### Fourteenth Modification Example

The provision information generation unit 122 detects an obstacle in the combined three-dimensional information. The method for detecting an obstacle may be any of various existing methods. The provision information generation unit 122 may detect an obstacle as follows, for example.

The provision information generation unit 122 detects a floor surface in the combined three-dimensional information. For example, the provision information generation unit 122 may detect an approximate plane existing below the position of the wearable terminal 200 in the vertical direction as the floor surface. For example, in the combined three-dimensional information, the provision information generation unit 122 may detect, as an obstacle, an area in which points having different heights from the detected floor surface are distributed at a predetermined density or more in a predetermined range in front of the wearable terminal. The provision information generation unit 122 may detect areas of a wall and a ceiling in the combined three-dimensional information and exclude the areas of the wall and the ceiling from the detected obstacles. For example, the provision information generation unit 122 may detect a horizontal plane (for example, a surface parallel to the detected floor surface) higher than the wearable terminal 200 as a ceiling. For example, the provision information generation unit 122 may detect a vertical plane (for example, a surface orthogonal to the detected floor surface) extending from the floor surface to the ceiling as a wall. The provision information generation unit 122 may divide the space in which the points of the combined three-dimensional information are distributed into a plurality of three-dimensional bodies and calculate a distribution of points having different heights from the floor surface for each three-dimensional body. The predetermined range in front is, for example, a range within a predetermined distance and within a predetermined angle from the front side. The points having the different height from the floor surface are, for example, points at which the distance from the approximate plane detected as the floor surface is a predetermined distance or more.

The method of detecting an obstacle is not limited to the above example. For example, the provision information generation unit 122 may detect an object using a difference in color, brightness, pattern, and the like in the image captured by the camera of the wearable terminal 200. The provision information generation unit 122 may use the detected object as an obstacle. The provision information generation unit 122 may detect both the obstacle detected from the combined three-dimensional information and the object detected from the image as obstacles.

The combined three-dimensional information of the present modification example may be combined three-dimensional information generated from the measurement data of one wearable terminal. The combined three-dimensional information may be three-dimensional information generated from the measurement data of a plurality of wearable terminals.

The provision information generation unit 122 generates information indicating an obstacle. The information indicating the obstacle may be, for example, information indicating a range of the obstacle in an image captured in the position and direction of the camera of the wearable terminal 200. The information indicating the range of the obstacle may be, for example, information indicating a shape such as a rectangle, a circle, or an ellipse surrounding the range of the figure of the obstacle. The information indicating the range of the obstacle may be, for example, an image in which pixel values of pixels included in the range of the figure of the obstacle in the image captured in the position and direction of the camera of the wearable terminal 200 are different from pixel values of pixels not included in the range of the figure of the obstacle. The information indicating the range of the obstacle may be, for example, coordinates of a feature point such as a center of gravity of a figure of the obstacle in the image captured in the position and direction of the camera of the wearable terminal 200. The information indicating the range of the obstacle may be, for example, coordinates of a feature point such as a center of gravity of a shape surrounding the figure of the obstacle in the image captured in the position and direction of the camera of the wearable terminal 200. The information indicating the range of the obstacle is not limited to the above example.

The provision information generation unit 122 transmits the generated information indicating the obstacle to the wearable terminal 200 as the provision information.

The control unit 220 of the wearable terminal 200 receives the information indicating the obstacle from the information providing device 100 as the provision information. The control unit 220 displays the information indicating the obstacle on the notification execution unit 240 that is a display. The control unit 220 may superimpose the information indicating the obstacle on an image obtained by capturing of the camera of the wearable terminal 200. When the information indicating the obstacle indicates a shape, the control unit 220 superimposes the shape indicated by the information indicating the obstacle on the image obtained by capturing by the camera of the wearable terminal 200. When the information indicating the obstacle indicates a point, the control unit 220 superimposes a shape such as an arrow indicating the point indicated by the information indicating the obstacle on the image obtained by capturing of the camera of the wearable terminal 200. The control unit 220 displays, on the notification execution unit 240 that is a display, an image obtained by capturing of the camera of the wearable terminal 200 on which the information indicating the obstacle is superimposed.

When the information indicating the obstacle is an image representing the area of the obstacle, the control unit 220 may change the color of the area of the obstacle indicated by the shape of the information indicating the obstacle in the image obtained by capturing of the camera of the wearable terminal 200. The control unit 220 displays, on the notification execution unit 240 that is a display, the image obtained by capturing of the camera of the wearable terminal 200 in which the color of the obstacle area has been changed.

### Fifteenth Modification Example

A fifteenth modification example is the same as the fourteenth modification example except for differences described below.

The space information generation unit 121 of the fifteenth modification example generates return path information as in the seventh or eighth modification example.

The provision information generation unit 122 of the present modification example extracts an obstacle in the combined three-dimensional information as in the fourteenth modification example. The provision information generation unit 122 removes, from the detected obstacle, an obstacle that becomes an obstacle when passing through a path indicated by the generated return path information from the extracted obstacle. In other words, the provision information generation unit 122 removes an obstacle that does not become an obstacle when passing through a path indicated by the generated return path information from the detected obstacle.

The obstacle that becomes an obstacle when passing through the path indicated by the generated return path information is, for example, an obstacle that is at least partially included in a space above an area having a predetermined width centered on a line segment of the path indicated by the return path information on the floor surface. The obstacle that does not become an obstacle when passing through the path indicated by the generated return path information is, for example, an obstacle that is not included in a space above an area having a predetermined width centered on a line segment of the path indicated by the return path information on the floor surface. The space above an area having a predetermined width centered on the line segment of the path indicated by the return path information is, for example, a space added by an area having a predetermined width centered on the line segment of the path indicated by the return path information on the floor surface when the area is moved to the ceiling perpendicularly to the floor surface.

The provision information generation unit 122 transmits a display representing the return path similar to that of the seventh modification example and information indicating the obstacle similar to that of the fourteenth modification example to the wearable terminal 200 as the provision information.

The control unit 220 of the wearable terminal 200 receives the display representing the return path and the information indicating the obstacle from the information providing device 100. As in the seventh modification example, the control unit 220 displays a display representing the return path on the notification execution unit 240 that is a display. In addition, as in the fourteenth modification example, the control unit 220 displays information indicating an obstacle on the notification execution unit 240 that is a display.

### Sixteenth Modification Example

A sixteenth modification example is the same as the seventh or eighth modification example except for differences described below.

The provision information generation unit 122 generates audio data indicating a return path, for example, at every predetermined time interval. The audio data indicating the return path is, for example, audio data of a message describing a direction of the return path with reference to the direction of the wearable terminal 20.

The provision information generation unit 122 transmits the generated audio data indicating the return path to the wearable terminal 200 as the provision information.

The control unit 220 of the wearable terminal 200 receives the audio data indicating the return path from the information providing device 100 as the provision information. The control unit 220 causes the notification execution unit 240, which is an audio reproduction device such as a speaker, an earphone, or a headphone, to reproduce the received audio data indicating the return path as audio.

In the present modification example, as in the seventh and eighth modification examples, the provision information generation unit 122 may transmit the display representing the return path to the wearable terminal 200 as the provision information. In that case, as in the seventh and eighth modification examples, the control unit 220 of the wearable terminal 200 receives the display representing the return path, and displays the received display representing the return path on the notification execution unit 240 that is a display.

In the present modification example, unlike the seventh and eighth modification examples, the provision information generation unit 122 is not required to transmit the display representing the return path to the wearable terminal 200 as the provision information. In that case, unlike the seventh and eighth modification examples, the control unit 220 of the wearable terminal 200 does not display the display representing the received return path on the notification execution unit 240 that is a display.

### Seventeenth Modification Example

A seventeenth modification example is the same as the fourteenth modification example except for differences described below.

The provision information generation unit 122 generates audio data indicating an obstacle at a predetermined timing, for example. The audio data indicating the obstacle is, for example, audio data of a message for describing a degree of proximity (for example, immediately near, near, far, or the like) and a direction of the obstacle with reference to the position and the direction of the wearable terminal 20. The audio data indicating the position of the obstacle may be, for example, audio data of a message describing the direction of the obstacle with reference to the direction of the wearable terminal 20.

The provision information generation unit 122 transmits the generated audio data indicating the obstacle to the wearable terminal 200 as the provision information.

The control unit 220 of the wearable terminal 200 receives the audio data indicating the obstacle as the provision information from the information providing device 100. The control unit 220 causes the notification execution unit 240, which is an audio reproduction device such as a speaker, an earphone, or a headphone, to reproduce the received audio data indicating the obstacle as audio.

In the present modification example, the provision information generation unit 122 may transmit a display representing an obstacle to the wearable terminal 200 as the provision information, as in the fourteenth modification example. In that case, the control unit 220 of the wearable terminal 200 receives the display representing the obstacle and displays the received display representing the obstacle on the notification execution unit 240 that is a display, as in the fourteenth modification example.

In the present modification example, unlike the fourteenth modification example, the provision information generation unit 122 is not required to transmit the display representing the obstacle to the wearable terminal 200 as the provision information. In that case, unlike the fourteenth modification example, the control unit 220 of the wearable terminal 200 does not display the received display representing the obstacle on the notification execution unit 240 that is a display.

### Eighteenth Modification Example

An eighteenth modification example is the same as the fifteenth modification example except for differences described below.

The provision information generation unit 122 generates audio data indicating a return path, for example, at every predetermined time interval. The audio data indicating the return path is, for example, audio data of a message describing a direction of the return path with reference to the direction of the wearable terminal 20.

The provision information generation unit 122 transmits the generated audio data indicating the return path to the wearable terminal 200 as the provision information.

The provision information generation unit 122 generates audio data indicating an obstacle at a predetermined timing, for example. The audio data indicating the obstacle is, for example, audio data of a message for describing a degree of proximity (for example, immediately near, near, far, or the like) and a direction of the obstacle with reference to the position and the direction of the wearable terminal 20. The audio data indicating the position of the obstacle may be, for example, audio data of a message describing the direction of the obstacle with reference to the direction of the wearable terminal 20.

The provision information generation unit 122 transmits the generated audio data indicating the obstacle to the wearable terminal 200 as the provision information.

The control unit 220 of the wearable terminal 200 receives the audio data indicating the return path from the information providing device 100 as the provision information. The control unit 220 causes the notification execution unit 240, which is an audio reproduction device such as a speaker, an earphone, or a headphone, to reproduce the received audio data indicating the return path as audio.

The control unit 220 of the wearable terminal 200 receives the audio data indicating the obstacle as the provision information from the information providing device 100. The control unit 220 causes the notification execution unit 240, which is an audio reproduction device such as a speaker, an earphone, or a headphone, to reproduce the received audio data indicating the obstacle as audio.

In the present modification example, as in the seventh and eighth modification examples, the provision information generation unit 122 may transmit the display representing the return path to the wearable terminal 200 as the provision information. In that case, as in the seventh and eighth modification examples, the control unit 220 of the wearable terminal 200 receives the display representing the return path, and displays the received display representing the return path on the notification execution unit 240 that is a display.

In the present modification example, the provision information generation unit 122 is not required to transmit the display representing the return path to the wearable terminal 200 as the provision information. In that case, the control unit 220 of the wearable terminal 200 does not display the received display representing the return path on the notification execution unit 240 that is a display.

In the present modification example, the provision information generation unit 122 may transmit a display representing an obstacle to the wearable terminal 200 as the provision information, as in the fourteenth modification example. In that case, the control unit 220 of the wearable terminal 200 receives the display representing the obstacle and displays the received display representing the obstacle on the notification execution unit 240 that is a display, as in the fourteenth modification example.

In the present modification example, the provision information generation unit 122 is not required to transmit the display representing the obstacle to the wearable terminal 200 as the provision information. In that case, the control unit 220 of the wearable terminal 200 does not display the received display representing the obstacle on the notification execution unit 240 that is a display.

### Nineteenth Modification Example

Combinations of any one or more of the first to eighteenth modification examples can also be applied to the second example embodiment.

When the wearable terminal 200 is smart glasses, the control unit 220 of the wearable terminal 200 does not superimpose the display of the provision information by the combination of any one or more of the first to eighteenth modification examples on the video captured by the camera of the wearable terminal 200. The control unit 220 may display the provision information such that the display of the provision information according to any one or more of the combinations of the first to eighteenth modification examples appears to overlap with a range visible through lenses of the smart glasses.

When the wearable terminal 200 is the smart glasses, the provision information generation unit 122 may generate two different images of an image for the right eye and an image for the left eye as images representing the provision information. The provision information generation unit 122 transmits the image for the right eye and the image for the left eye to the wearable terminal 200 as the provision information. The control unit 220 of the wearable terminal 200 receives the image for the right eye and the image for the left eye as the provision information, and displays the image for the right eye and the image for the left eye such that the image for the right eye is visible to the right eye and the image for the left eye is visible to the left eye.

In this case, the provision information generation unit 122 may generate two images such that one image represents the display of the provision information according to any one or more combinations of the first to eighteenth modification examples, and the other image represents, for example, a message input by an operator of the information providing device 100. The provision information generation unit 122 may generate two images in which one image represents the provision information according to any one or more combinations of the first to eighteenth modification examples such that stereoscopic vision is possible in a case where display is performed such that the image for the right eye is visible to the right eye and the image for the left eye is visible to the left eye.

### Other Example Embodiment

The information providing device 10, the information providing device 100, and the wearable terminal 200 according to the example embodiments of the present disclosure can be achieved by a computer including a memory in which a program read from a storage medium is loaded and a processor that executes the program. The information providing device 10, the information providing device 100, and the wearable terminal 200 according to the example embodiments of the present disclosure can also be achieved by dedicated hardware. The information providing device 10, the information providing device 100, and the wearable terminal 200 according to the example embodiments of the present disclosure can also be achieved by a combination of the above-described computer and dedicated hardware.

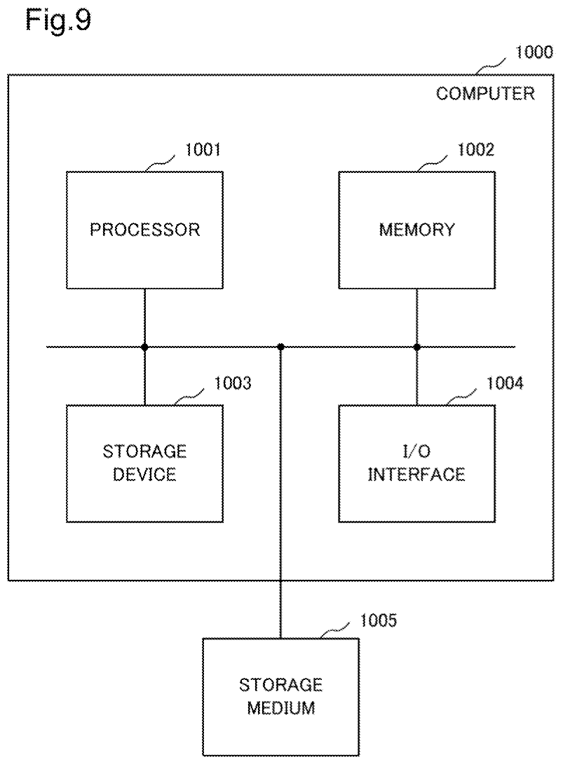

FIG. 9 is a diagram illustrating an example of a hardware configuration of a computer 1000 that can implement the information providing device 10, the information providing device 100, and the wearable terminal 200 according to the example embodiments of the present disclosure. In the example illustrated in FIG. 9, the computer 1000 includes a processor 1001, a memory 1002, a storage device 1003, and an input/output (I/O) interface 1004. The computer 1000 can access the storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and to the memory 1002 and the storage device 1003. The processor 1001 can access, for example, other devices via the I/O interface 1004. The processor 1001 can access the storage medium 1005. The storage medium 1005 stores a program for causing the computer 1000 to operate as the information providing device according to the example embodiments of the present disclosure. The storage medium 1005 can store a program for causing the computer 1000 to operate as the wearable terminal according to the example embodiments of the present disclosure.

The processor 1001 loads, into the memory 1002, a program that is stored in the storage medium 1005 and causes the computer 1000 to operate as the information providing device according to the example embodiments of the present disclosure. Then, the processor 1001 executes the program loaded in the memory 1002, and thereby the computer 1000 operates as the information providing device according to the example embodiments of the present disclosure. The processor 1001 loads a program, which is stored in the storage medium 1005 and causes the computer 1000 to operate as the wearable terminal according to the example embodiments of the present disclosure, into the memory 1002. Then, the processor 1001 executes the program loaded in the memory 1002, and thereby the computer 1000 operates as the wearable terminal according to the example embodiments of the present disclosure.

The reception unit 110, the generation unit 120, the space information generation unit 121, the provision information generation unit 122, and the transmission unit 130 can be implemented by, for example, the processor 1001 that executes a program loaded in the memory 1002. The data storage unit 140 can be achieved by the memory 1002 included in the computer 1000 or the storage device 1003 such as a hard disk device. Alternatively, a part or all of the reception unit 110, the generation unit 120, the space information generation unit 121, the provision information generation unit 122, the transmission unit 130, and the data storage unit 140 can be implemented by a dedicated circuit that implements functions of units.

The control unit 220 and the communication unit 230 can be achieved by, for example, the processor 1001 that executes a program loaded in the memory 1002. A part or all of the sensor unit 210, the control unit 220, the communication unit 230, and the notification execution unit 240 can be implemented by a dedicated circuit that implements functions of units.

A part or all of the example embodiments described above may also be described as in the following supplementary notes, but are not limited to the following.

(Supplementary Note 1)

An information providing device including:

a generation unit that generates three-dimensional information of a space in which a wearable terminal is present on the basis of measurement data measured by a sensor of the wearable terminal; and

a transmission unit that transmits provision information based on the three-dimensional information to the wearable terminal.

(Supplementary Note 2)

The information providing device according to supplementary note 1, further including

a provision information generation unit that generates the provision information on the basis of the three-dimensional information.

(Supplementary Note 3)

The information providing device according to supplementary note 2, further including

a position estimation unit that estimates a position of the wearable terminal in the space on the basis of the measurement data, in which

the provision information generation unit generates, as the provision information, path information that is information of a path of movement from the position to a specific location on the basis of the three-dimensional information and the position.

(Supplementary Note 4)

The information providing device according to supplementary note 3, in which

the provision information generation unit generates, as the provision information, a display based on the path information to be superimposed on a front video that is a video of a front of the wearable terminal.

(Supplementary Note 5)

The information providing device according to supplementary note 4, in which

the provision information generation unit generates the provision information on the basis of a past video captured in a past at a position and in a direction that satisfy a criterion based on the position and a direction of the wearable terminal.

(Supplementary Note 6)

The information providing device according to supplementary note 5, in which

the provision information generation unit detects a shielded portion of a captured video captured by the wearable terminal, and generates, as the provision information, a video of a portion related to the shielded portion of the past video to be superimposed on the shielded portion of the captured video.

(Supplementary Note 7)

The information providing device according to any one of supplementary notes 3 to 6, in which

the provision information generation unit generates the path information including information of a floor surface that is passable.

(Supplementary Note 8)

The information providing device according to any one of supplementary notes 3 to 7, in which

the provision information generation unit detects an obstacle that is possible to be an obstacle to movement along the path on the basis of the three-dimensional information, and generates the path information including information of the detected obstacle.

(Supplementary Note 9)

An information providing method including:

generating three-dimensional information of a space in which a wearable terminal is present on the basis of measurement data measured by a sensor of the wearable terminal; and

transmitting provision information based on the three-dimensional information to the wearable terminal.

(Supplementary Note 10)

The information providing method according to supplementary note 9, in which

the provision information is generated on the basis of the three-dimensional information.

(Supplementary Note 11)

The information providing method according to supplementary note 10, further including

estimating a position of the wearable terminal in the space on the basis of the measurement data, in which

path information that is information of a path of movement from the position to a specific location is generated as the provision information on the basis of the three-dimensional information and the position.

(Supplementary Note 12)

The information providing method according to supplementary note 11, in which

a display based on the path information to be superimposed on a front video that is a video of a front of the wearable terminal is generated as the provision information.

(Supplementary Note 13)

The information providing method according to supplementary note 12, in which

the provision information is generated on the basis of a past video captured in a past at a position and in a direction that satisfy a criterion based on the position and a direction of the wearable terminal.

(Supplementary Note 14)

The information providing method according to supplementary note 13, in which

a shielded portion of a captured video captured by the wearable terminal is detected, and a video of a portion related to the shielded portion of the past video to be superimposed on the shielded portion of the captured video is generated as the provision information.

(Supplementary Note 15)

The information providing method according to any one of supplementary notes 11 to 14, in which

the path information including information of a floor surface that is passable is generated.

(Supplementary Note 16)

The information providing method according to any one of supplementary notes 11 to 15, in which

an obstacle that is possible to be an obstacle to movement along the path is detected on the basis of the three-dimensional information, and the path information including information of the detected obstacle is generated.

(Supplementary Note 17)

A program for causing a computer to execute:

a generation process of generating three-dimensional information of a space in which a wearable terminal is present on the basis of measurement data measured by a sensor of the wearable terminal; and

a transmission process of transmitting provision information based on the three-dimensional information to the wearable terminal.

(Supplementary Note 18)

The program according to supplementary note 17, further causing a computer to execute

a provision information generation process of generating the provision information on the basis of the three-dimensional information.

(Supplementary Note 19)

The program according to supplementary note 18, further causing the computer to execute

a position estimation process of estimating a position of the wearable terminal in the space on the basis of the measurement data, in which

the provision information generation process generates, as the provision information, path information that is information of a path of movement from the position to a specific location on the basis of the three-dimensional information and the position.

(Supplementary Note 20)

The program according to supplementary note 19, in which

the provision information generation process generates, as the provision information, a display based on the path information to be superimposed on a front video that is a video of a front of the wearable terminal.

(Supplementary Note 21)

The program according to supplementary note 20, in which

the provision information generation process generates the provision information on the basis of a past video captured in a past at a position and in a direction that satisfy a criterion based on the position and a direction of the wearable terminal.

(Supplementary Note 22)

The program according to supplementary note 21, in which

the provision information generation process detects a shielded portion of a captured video captured by the wearable terminal, and generates, as the provision information, a video of a portion related to the shielded portion of the past video to be superimposed on the shielded portion of the captured video.

(Supplementary Note 23)

The program according to any one of supplementary notes 19 to 22, in which

the provision information generation process generates the path information including information of a floor surface that is passable.

(Supplementary Note 24)

The program according to any one of supplementary notes 19 to 23, in which

the provision information generation process detects an obstacle that is possible to be an obstacle to movement along the path on the basis of the three-dimensional information, and generates the path information including information of the detected obstacle.

In disaster sites such as fire sites, workers such as paramedic personnel are at risk. The technology of JP 2020-160696 A can prevent leakage of confidential information by inhibiting transmission of image information of an area not included in the maintenance work area, but cannot improve safety of the workers. The technology disclosed in JP 2020-020987 A can prevent information suitable for a specific occupant from being presented to other occupants, but cannot improve safety of the workers. The technique of JP 2020-030704 A can support alignment with respect to an object, but cannot improve safety of the workers.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents. Further, it is noted that the inventor's intent is to retain all equivalents of the claimed invention even if the claims are amended during prosecution.

1. An information providing device comprising:
at least one memory; and
at least one processor configured to execute instructions to:
generate, based on measurement data, three-dimensional information of a space in which a wearable terminal is present, the measurement data being measured by a sensor of the wearable terminal; and
transmit provision information based on the three-dimensional information to the wearable terminal.

2. The information providing device according to claim 1, wherein
the at least one processor is further configured to execute instructions to
generate the provision information based on the three-dimensional information.

3. The information providing device according to claim 2, wherein
the at least one processor is further configured to execute instructions to:
estimate a position of the wearable terminal in the space based on the measurement data; and
generate, as the provision information, path information based on the three-dimensional information and the position, the path information being information of a path of movement from the position to a specific location.

4. The information providing device according to claim 3, wherein
the at least one processor is further configured to execute instructions to
generate, as the provision information, a display based on the path information, the display being to be superimposed on a front video that is a video of a front of the wearable terminal.

5. The information providing device according to claim 4, wherein
the at least one processor is further configured to execute instructions to
generate the provision information based on a past video captured in a past at a position and in a direction, the position and the direction satisfying a criterion based on the position and a direction of the wearable terminal.

6. The information providing device according to claim 5, wherein
the at least one processor is further configured to execute instructions to:
detect a shielded portion of a captured video captured by the wearable terminal; and
generate, as the provision information, a video of a portion related to the shielded portion of the past video to be superimposed on the shielded portion of the captured video.

7. The information providing device according to claim 3, wherein
the at least one processor is further configured to execute instructions to
generate the path information including information of a floor surface that is passable.

8. The information providing device according to claim 3, wherein
the at least one processor is further configured to execute instructions to:
detect an obstacle that is possible to be an obstacle to movement along the path based on the three-dimensional information; and
generate the path information including information of the detected obstacle.

9. An information providing method comprising:
generating, based on measurement data, three-dimensional information of a space in which a wearable terminal is present, the measurement data being measured by a sensor of the wearable terminal; and
transmitting provision information based on the three-dimensional information to the wearable terminal.

10. A non-transitory computer readable storage medium storing a program causing a computer to execute:
generation processing of generating, based on measurement data, three-dimensional information of a space in which a wearable terminal is present, the measurement data being measured by a sensor of the wearable terminal; and
transmission processing of transmitting provision information based on the three-dimensional information to the wearable terminal.
